(19) United States
(12) Patent Application Publication
(10) Pub. No.: US 2010/0132367 A1
(43) Pub. Date: Jun. 3, 2010

(54) DEVICE FOR MOVING A PLURALITY OF HATCHES IN A GAS TURBINE ENGINE

(75) Inventor: Rustan Brogren, Vanersborg (SE)

Correspondence Address: WRB-IP LLP, 1217 KING STREET, ALEXANDRIA, VA, 22314, US

(73) Assignee: VOLVO AERO CORPORATION, Trollhattan (SE)

(21) Appl. No.: 12/598,233

(22) PCT Filed: Jul. 2, 2007
(86) PCT No.: PCT/SE2007/000652

§ 371 Date: Oct. 30, 2009

(30) Foreign Application Priority Data
May 25, 2007 (SE) 0701281-8

(51) Int. Cl. F02C 6/04; G05G 7/00; G05G 11/00

(52) U.S. Cl. 60/785; 74/469; 74/479.01

(57) ABSTRACT

A device is provided for moving a plurality of hatches, spaced at intervals from one another in a circumferential direction of a gas turbine engine, between a first position and a second position, wherein each of the hatches is arranged to keep an opening in a wall in a closed position, when in the first position, and to keep the opening in an open position, when in the second position. At least one of the hatches is provided with two connecting members which are mutually separated in the circumferential direction of the device, and the device includes a linkage for the movement, the linkage being connected to the hatch at the two mutually separated connecting members.

### BACKGROUND AND SUMMARY

The present invention relates to a device for moving a plurality of hatches, spaced at intervals from one another in a circumferential direction of a gas turbine engine, between a first position and a second position, wherein each of the hatches is arranged to keep an opening in a wall in a closed position, when in the first position, and to keep the opening in an open position, when in the second position. The invention also relates to a gas turbine engine, especially an aircraft engine, comprising the device.

The device can be used in order to regulate the tapping (bleeding) of air. The device will be described below for opening and closing openings in a wall, which defines a gas duct for bleeding air. A plurality of bleed openings are conventionally spaced at intervals from one another in a circumferential direction around the gas duct and through the gas duct wall. A corresponding number of hatches are correspondingly spaced at intervals from one another in a circumferential direction and form doors, designed to control the degree of opening of the openings.

The device will be described for a jet engine in an aircraft. In known aircraft engines, a bleed line extends between a primary gas duct and a secondary gas duct for bleeding off air from the primary gas duct to the secondary gas duct. In certain operational conditions, compressed air is bled off from the primary gas duct via the bleed line and is introduced into a high-velocity flow in the secondary gas duct.

The term jet engine is intended to encompass different types of engines, which admit air at a relatively low velocity, heat it up through combustion, and expel it at a much higher velocity. Accommodated within the term jet engine are, for example, turbojet engines and turbofan engines. The invention will below be described for a turbofan engine, but may of course also be used for other engine types.

U.S. Pat. No. 6,742,324 discloses a valve system for the variable control of gas bypass.

The system comprises a unison ring, which is arranged radially outside a gas duct wall. The ring is connected to a bypass hatch, which covers an opening through the wall, via a bell-crank lever. The ring is pivotally arranged in a circumferential direction and the hatch is opened and closed, respectively, when the ring is pivoted in its circumferential direction. The bell-crank lever is connected to the hatch via a connecting member, or lug, situated on the hatch.

It is desirable to achieve a device for moving a plurality of hatches in a gas turbine engine, which represents an alternative to known solutions. The invention particularly intends to achieve a longer service live than previously known such devices.

According to an aspect of the present invention, a device is provided for moving a plurality of hatches, spaced at intervals from one another in a circumferential direction of a gas turbine engine, between a first position and a second position, wherein each of the hatches is arranged to keep an opening in a wall in a closed position, when in the first position, and to keep the opening in an open position, when in the second position, characterized in that at least one of said hatches is provided with two connecting members which are mutually separated in the circumferential direction of the device, and that the device comprises a linkage for said movement, said linkage being connected to the hatch at said two mutually separated connecting members.

Preferably, at least two of said hatches, suitably at least three of said hatches, especially more than half of the hatches, and preferably all of the hatches, are provided with two connecting members, which are mutually separated in the circumferential direction of the device, and such a linkage.

A linkage arranged in this way creates the prerequisites for a robust and simple solution for moving the respective hatch between said positions in an accurate fashion. By means of providing at least three of the hatches with such a linkage, suitably at regular intervals in a circumferential direction, a smooth and reliable opening and closing action can be achieved. Accordingly, the hatch is suspended at two points which are mutually spaced in its transverse direction, preferably at the edges of the hatch.

According to a preferred embodiment, the linkage comprises a cross bar, extending across a distance in the circumferential direction of the device which substantially corresponds to the distance between the connecting members. In this case, the cross bar has the function of a stabilizer (or anti-sway device).

According to another preferred embodiment, the linkage comprises two motion-transmitting members, each of which being connected to one of connecting members of the hatch. The motion-transmitting members are preferably parallel to each other, arranged at a mutual distance and with an extension direction perpendicular to a pivot joint defined by the connecting members of the hatch. The cross bar is preferably arranged between the motion-transmitting members and fixedly attached to them.

According to another preferred embodiment, the device comprises a moveable annular member, which is arranged externally around the wall and connected to said linkage in order to effect the movement of the hatch. The annular member is preferably arranged to be displaced relative to the wall in a substantially axial direction and arranged to move the hatch when it is axially displaced. Such an axial, linear movement creates the prerequisites for a reliable function in operation. Furthermore, smaller friction losses are obtained. In addition, the device is less sensitive to problems with different rates of expansion of the different constituent components, which can occur owing to thermal loads.

Especially, the linkage creates the prerequisites for a simple and robust connection to the annular member.

Accordingly, the linkage forms a motion-transmitting member, which mechanically connects the axially displaceable annular member and the respective hatch. An axial displacement of the annular member will therefore be transmitted to the hatch via a parallel movement of the linkage, which creates the prerequisites for a reliable function in operation.

According to a preferred embodiment of the invention, the device comprises an actuator, which is connected to the annular member for displacement of the annular member between a first and a second position, said positions corresponding to the first and the second position of the hatch. Furthermore, the linkage is arranged to control the axial movement of the annular member, so that the movement becomes smooth and accurate. Thereby, multiple linkages are preferably arranged at opposite sides of the gas duct and preferably with substantially the same spacing from one another in the circumferential direction. The movement is also ensured for example in the event of an actuator-failure (provided that the device comprises several actuators).

According to a preferred embodiment of the invention, the connecting members, or lugs, of the hatch are arranged at a substantial distance from one another in the circumferential direction of the gas duct. Herein, a substantial distance means a distance such that the linkage can perform its function as a stabilizer between the connecting members. The two connecting members are preferably arranged at opposite edges of the hatch in the circumferential direction of the gas duct. Thus, the linkage extends along substantially the entire width of the hatch in the circumferential direction of the gas duct.

According to a preferred embodiment of the invention, the two connecting members define a first pivot joint, and the linkage is pivotally arranged relative to the hatch about the first pivot joint.

Further advantageous embodiments and further advantages of the invention are evident from the detailed description below, and the drawings.

### BRIEF DESCRIPTION OF TUE DRAWINGS

The invention will be explained below with reference to the embodiments shown in the accompanying drawings, in which:

FIG. 1 is a schematic illustration of an aircraft turbofan engine, in a longitudinal cross-section;

FIG. 2 shows a perspective view of a device for bleeding air from a primary gas duct in the engine shown in FIG. 1, wherein the air bleed hatches are closed;

FIG. 3 shows the device according to FIG. 2, wherein the air bleed hatches are open;

FIG. 4 shows a cross bar for one of the air bleed hatches shown in FIG. 2, in a perspective view;

FIGS. 5, 6 show the hatch and the cross bar in FIG. 4 in side views, in a closed and an open position of the hatch; and

FIG. 7 shows the cross bar in a top view.

### DETAILED DESCRIPTION

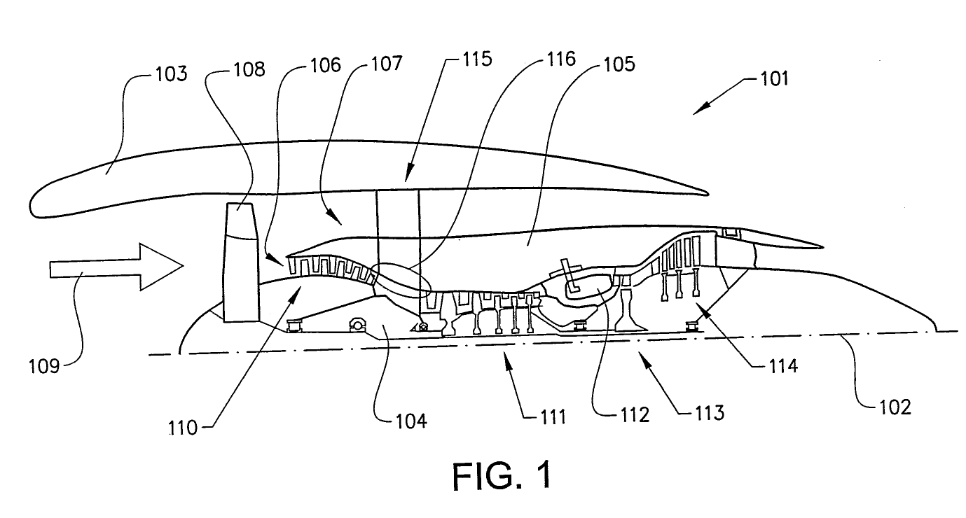

The invention will be described below for an aircraft turbofan engine 101, which in FIG. 1 circumscribes a longitudinal engine central axis 102. The engine 101 comprises an outer casing 103, an inner casing 104 and an intermediate casing 105, which is concentric to the first two casings and divides the gap between these into an inner primary gas duct 106 for the compression of air and a secondary duct 107 in which the engine bypasses air flows. Thus, each of the gas ducts 106, 107 is annular in a cross-section perpendicular to the longitudinal central axis 102 of the engine.

The engine 101 comprises a fan 108 which admits ambient air 109, a booster or low pressure compressor (LPC) 110 and a high-pressure compressor (HPC) 111 arranged in the primary gas duct 106, a combustion chamber 112 which mixes fuel with the air pressurized by the high-pressure compressor 111 in order to generate combustion gases, which flow downstream through a high-pressure turbine (HPT) 113 and a low-pressure turbine (LPT) 114, from whence the combustion gases flow out of the engine.

A high-pressure shaft connects the high-pressure turbine 113 to the high-pressure compressor 111 in order to form a high-pressure rotor. A low pressure shaft connects the low-pressure turbine 114 to the low-pressure compressor 110 in order to form a low-pressure rotor. The high-pressure compressor 111, the combustion chamber 112 and the high-pressure turbine 113 are collectively referred to as a core engine. The low-pressure shaft is at least in part disposed rotatably, co-axially with, and radially inwardly of the high-pressure rotor.

A load-bearing engine structure 115 is arranged between the outer casing 103 and the inner casing 104. The load-bearing engine structure 115 is usually referred to as the “fan hub frame”.

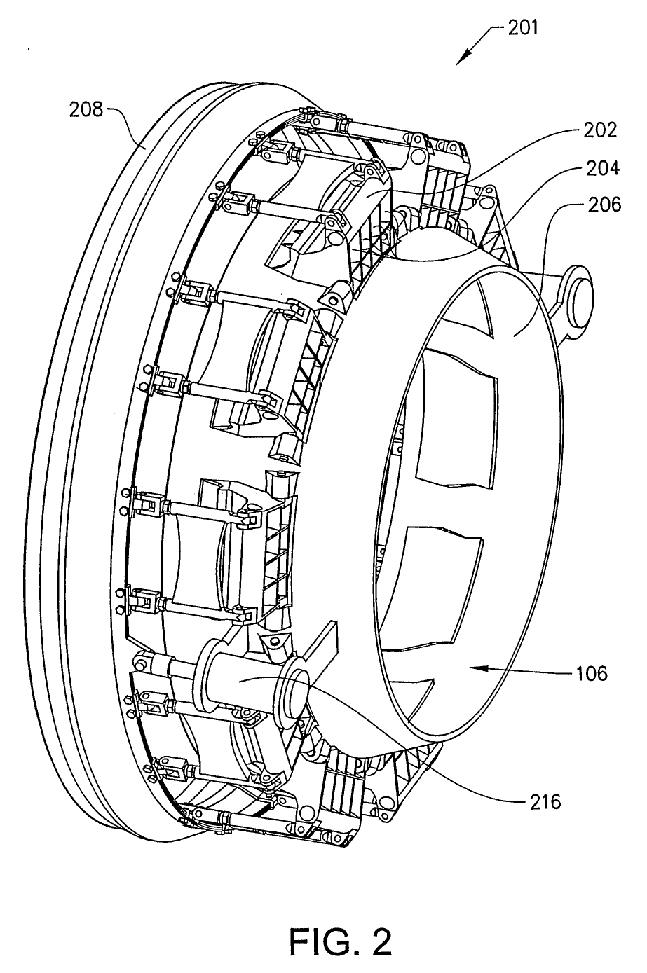

FIGS. 2-5 show a device 201 for controlling the bleeding of gas in the gas turbine engine 101.

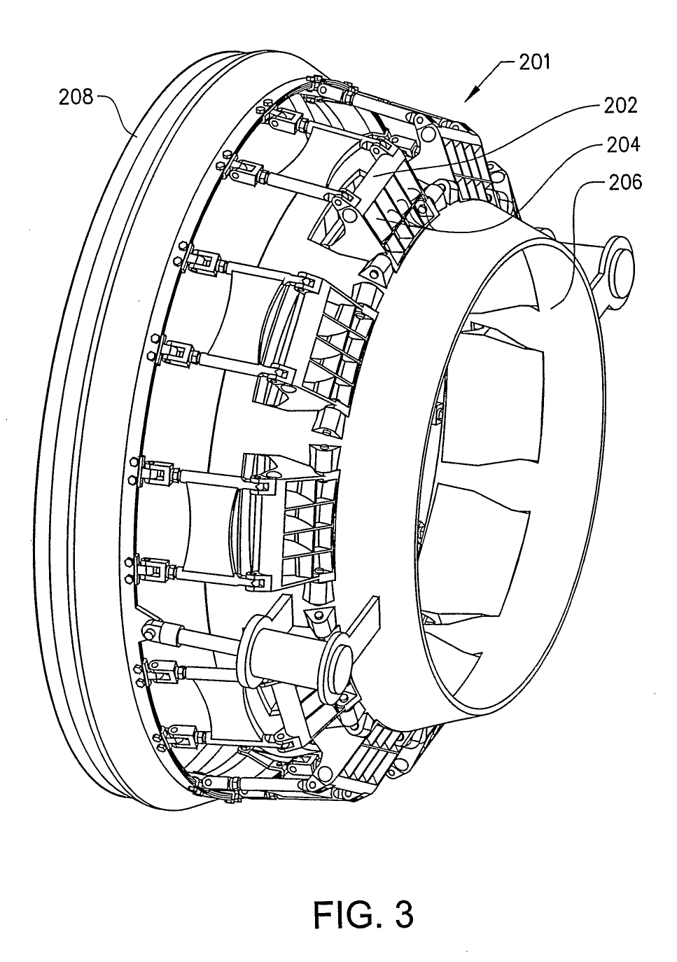

FIGS. 2 and 3 show the air bleeding device 201 for moving a plurality of hatches 202 between a first position and a second position, wherein each hatch is arranged to keep an opening 204 in a wall 206 in a closed position, when in the first position, and to keep the opening 204 in an open position, when in the second position. More specifically, the device 201 is arranged for bleeding air from the primary gas duct 106. The position of the air bleeding device 201 is indicated by the reference numeral 116 in FIG. 1. Accordingly, the air bleeding device 201 is arranged between the low-pressure compressor 110 and the high-pressure compressor 111.

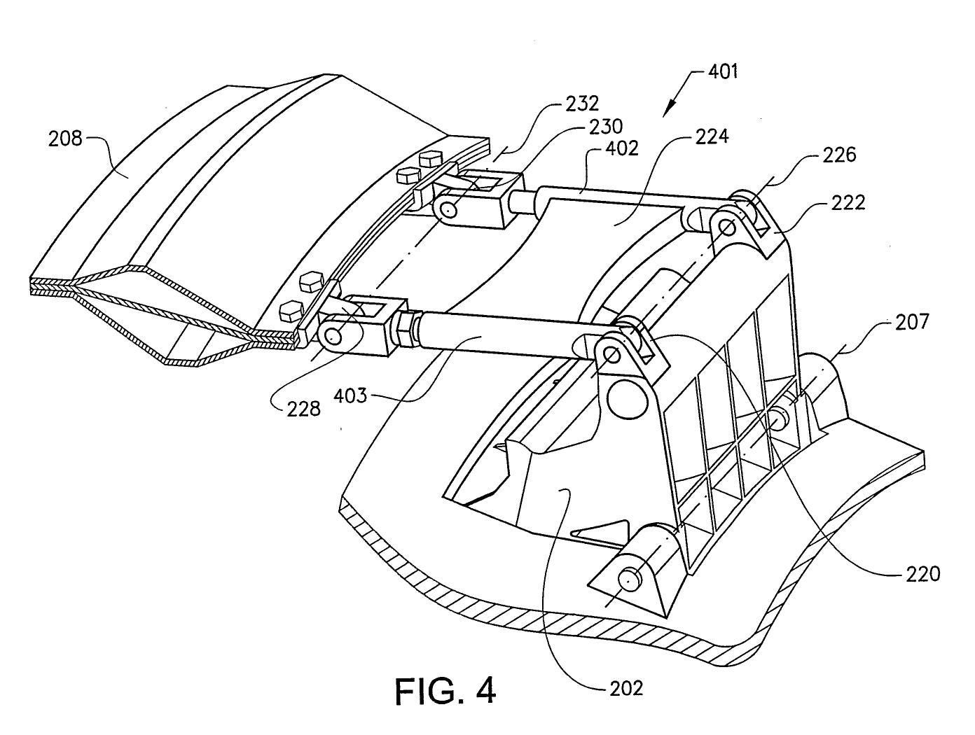

A plurality of openings 204 spaced at intervals from one another in a circumferential direction are provided through a wall 206, which externally defines the primary gas duct 106. A hatch 202 is positioned at each opening 204 and arranged to open and close the opening. The hatches 202 cover the openings 204 completely in the closed position. The hatches 202 are arranged with different angles in the first and second positions. More specifically, the pivotable elements 202 are pivoted about an axis 207, see FIG. 4, which extends at right angles to the axial direction 102 of the gas turbine, between the first and the second position. The hatches 202 are arranged to be continuously adjustable to assume any position between the first and second end position. Accordingly, the air bleeding device 201 constitutes a valve system for variable control of the gas bypass.

Bleed lines (not shown) are connected to each of the openings 204 and extend between the primary gas duct 106 and the secondary gas duct 107. The bleed lines form a flow path for ducting air from the primary gas duct 106 to the secondary gas duct 107.

The air bleeding device 201 comprises an axially displaceable annular member 208, or guide ring, which is arranged externally around the gas duct 106 and arranged to be displaced in a substantially axial direction of the gas duct. In other words, the annular member 208 is arranged to be displaced at right angles to the plane in which it extends. The annular member 208 is connected to the hatches 202 in order to effect the pivoting of the hatches when it is displaced axially. Accordingly, the hatches 202 are arranged to be pivoted about the pivot joint 207, which extends at right angles to the axial direction of the annular member 208 (that is to say its central axis).

The annular member 208 is arranged radially outside a fixed wall 206, which defines the annular gas duct 106 and is axially displaceable relative to the wall. The annular member 208 is continuous in the circumferential direction and surrounds the primary gas duct. The annular member 208 constitutes a unison ring which is positioned radially inside the outer casing of the gas turbine, and inside the intermediate casing 105.

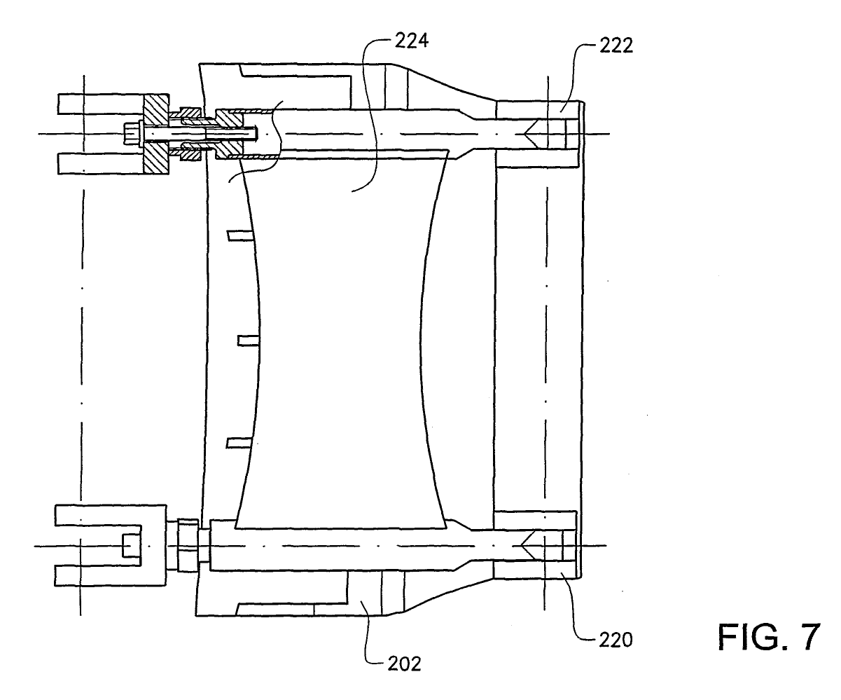

FIGS. 4-7 show a hatch 202 with an associated linkage 401 in greater detail. Each of the hatches 202 is provided with two mutually separated connecting members, or lugs, 220, 222. The linkage 401 comprises two parallel motion-transmitting members 402, 403, each of which being connected to one of the connecting members 228, 230 of the hatch 202. The connecting members 220, 222 of the hatch 202 are arranged at a substantial distance from one another in the circumferential direction of the gas duct and more specifically at opposite edges of the hatch 202 in the circumferential direction of the gas duct. The linkage 401 further comprises a cross bar 224, extending across a distance in the circumferential direction of the device which substantially corresponds to the distance between the connecting members 228, 230. The cross bar is fixedly connected to the motion-transmitting members 402, 403. The two connecting members 220, 222 define a first pivot joint 226, and the linkage 401, as a unit, is pivotally arranged relative to the hatch 202 about the first pivot joint 226. The cross bar 224 has an elongated extension between said connecting members 220, 222 and is substantially rigid. Accordingly, the cross bar has a main extension direction (with respect to its stiffening function) in a direction at right angles to the axial direction of the device. Each of the cross bars 224 constitute a torsionally rigid stabilizer (torsional member).

The hatch 202 further comprises a torsionally rigid structure 501, 502, which is arranged so that the hatch 202 is torsionally rigid in its transverse direction, that is to say in a direction at right angles to the axial direction of the device (that is to say in parallel with the extension direction of the cross bars 224). The torsionally rigid structure 501, 502 comprises a wall structure integrated in the hatch which defines two holes 501, 502, extending between the edges of the hatch 202 in its transverse direction. The torsionally rigid structure can of course also have another design, for example in the form of a torsionally rigid, elongated member, or profile, fixedly connected to the hatch, such as a tube having an extension in the transverse direction of the hatch.

Furthermore, the hatch 202 is pivotally arranged relative to the wall about said pivot joint 208 in connection to the opening 204, said pivot joint 207 thereby forming a second pivot joint. The first and second pivot joint 226, 207 are parallel to each other.

The annular member 208 is provided with two mutually separated connecting members 228, 230. The two parallel members 402, 403 are connected to the annular member 208 at said two mutually separated connecting members 228, 230. The connecting members 228, 230 of the annular member 208 are spaced at a distance from one another, in the circumferential direction of the annular member, which corresponds to the distance between the corresponding connecting members 220, 222 of the hatch. Accordingly, the linkage 401 has an H-shape. Naturally, it is within the scope of the invention that the distance between the connecting members 228, 230 of the annular member is different from the distance between the connecting members 220, 222 of the hatch. The two connecting members 228, 230 define a third pivot joint 232. The linkage 401 is pivotally arranged relative to the annular member 208 about the third pivot joint. The third pivot joint 232 is parallel to the first pivot joint 226.

Accordingly, the cross bar constitutes a motion-transmitting member, which mechanically connects the axially displaceable annular member 208 and the hatch 202.

Thus, the cross bars 224 support the axially displaceable annular member 208 relative to the fixed part 206, and are arranged to control the axial movement of the annular member 208.

The air bleeding device 201 further comprises a plurality of actuators 216, which are connected to the annular member 208 for displacement of the annular member between a first and a second position in the axial direction, said positions corresponding to the first and second position of the hatch 202. The actuators 216 are fixedly connected to a fixed part 206 of the gas turbine. The actuators 216 are constituted of a plurality, suitably an even number of hydraulic cylinders, which are spaced at intervals from one another in the circumferential direction of the gas turbine 101. The actuators are preferably controlled via at least two functionally separate systems, so that the movement is ensured also in the event of a failure in one of the systems. Thereby, the actuators are suitably arranged in pairs in the same system, wherein two such actuators are arranged at opposite sides of the gas duct 106. The connection between the respective actuator 216 and the ring 208 is suitably designed to allow for thermal expansion differences between the parts.

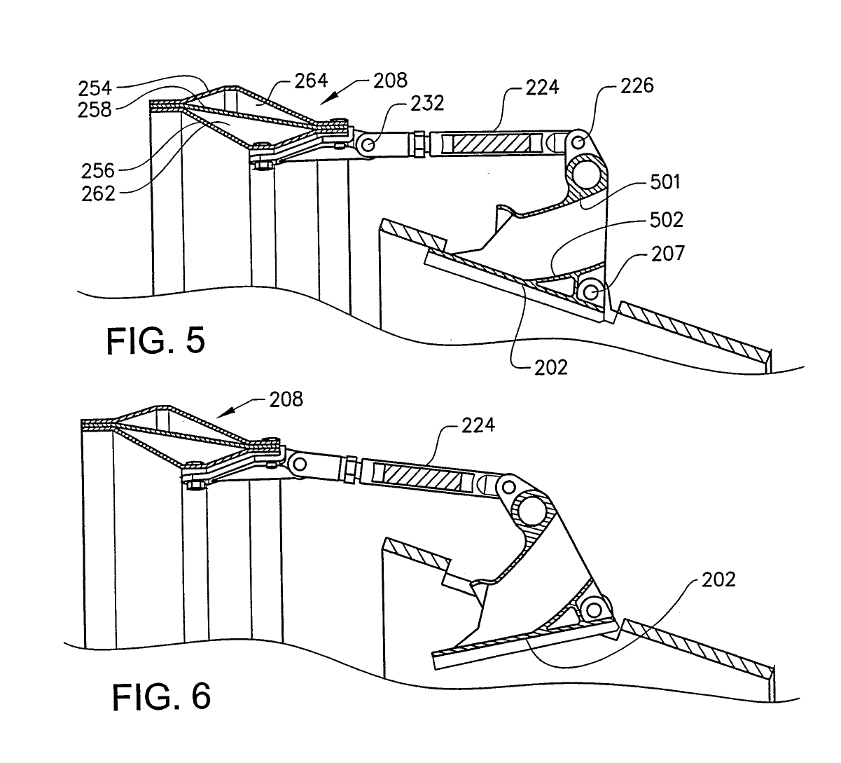

In FIGS. 2 and 5, the air bleeding device 201 is in a closed position, wherein the hatches 202 cover the openings 204 completely. In FIGS. 3 and 6, the air bleeding device 201 is in an open position, wherein the openings 204 are free.

The annular member 208 comprises a plurality of flanged, annular elements 254, 256, 258 in the form of plates, which are fixedly connected to one another and define an internal space 262.

More specifically, a first annular, angled plate 254 defines a radially outer part of the annular member 208 and a second annular, angled plate 254 defines a radially inner part of the annular member 208. A third annular plate 258 is arranged between the first and the second plate and connected to them at each end in an axial direction.

According to one variant, the internal space 262, 264 of the ring 208 can be filled with a material which gives the ring a greater rigidity, for example a hard foam material, suitably comprising a polymer material. This would create the prerequisites for using plates with thinner material thickness, and thus a weight reduction can be achieved.

The invention is in no way limited to the embodiment described in the foregoing, but instead a number of alternatives and modifications are possible without departing from the scope of the following claims.

According to one alternative, the air bleeding device is arranged downstream of the combustion chamber 112 for ducting air from the primary gas duct 106 to the secondary gas duct 107. More specifically, the air bleeding device can be arranged between the high-pressure turbine 113 and the low-pressure turbine 114.

According to a further alternative, the air bleeding device is not limited to an arrangement through an outer wall of the inner gas duct, such as the primary gas duct 106, but can also be arranged through a radially inner wall of an outer gas duct, such as the fan duct 107. In such a case, the annular member would naturally be arranged radially inside the outer gas duct.

Furthermore, the air bleeding device could be arranged radially outside the outer gas duct (fan duct).

Furthermore, the invention can be utilized for other gas turbine applications, such as for example vehicle engines, as power plants in vehicles, and in stationary applications, such as power plants for electricity production.

1. A device for moving a plurality of hatches, spaced at intervals from one another in a circumferential direction of a gas turbine engine, between a first position and a second position, wherein each of the hatches is arranged to keep an opening in a wall in a closed position, when in the first position, and to keep the opening in an open position, when in the second position, wherein at least one of the hatches is provided with two connecting members, which are mutually separated in the circumferential direction of the device, and the device comprises a linkage for the movement, the linkage being connected to the hatch at the two mutually separated connecting members.

2. A device according to claim 1, wherein the wall defines an annular gas duct.

3. A device according to claim 1, wherein the connecting members of the hatch are arranged at a substantial distance from one another.

4. A device according to claim 1, wherein the two connecting members are arranged at opposite edges of the hatch.

5. A device according to claim 1, wherein the linkage comprises a cross bar, extending across a distance in the circumferential direction of the device which substantially corresponds to the distance between the connecting members.

6. A device according to claim 5, wherein the cross bar extends along substantially the entire width of the hatch.

7. A device according to claim 1, wherein the linkage comprises two motion-transmitting members, each of which being connected to one of the connecting members of the hatch.

8. A device according to claim 5, wherein the linkage comprises two motion-transmitting members, each of which being connected to one of the connecting members of the hatch, and the cross bar is arranged between the motion-transmitting members and fixedly connected to them.

9. A device according to claim 1, wherein the two connecting members define a first pivot joint, and that the linkage is pivotally arranged relative to the hatch about the first pivot joint.

10. A device according to claim 1, wherein the hatch is pivotally arranged relative to the wall about a second pivot joint in connection to the opening.

11. A device according to claim 9, wherein the hatch is pivotally arranged relative to the wall about a second pivot joint in connection to the opening and the first and second pivot joint are parallel to each other.

12. A device according to claim 1, wherein the linkage is substantially rigid.

13. A device according to claim 1, wherein the device comprises a moveable annular member, which is arranged externally around the wall and
connected to the linkage in order to effect the movement of the hatches.

14. A device according to claim 13, wherein the annular member is arranged to be displaced relative to the wall in a substantially axial direction and arranged to move the hatch when it is axially displaced.

15. A device according to claim 13, wherein the annular member is provided with two mutually separated connecting members, and that the linkage is connected to the annular member at the two mutually separated connecting members.

16. A device according to claim 15, wherein the connecting members of the annular member are arranged at a distance from one another in the circumferential direction of the annular member.

17. A device according to claim 15, wherein the two connecting members define a third pivot joint, and that the linkage is pivotally arranged relative to the annular member about the third pivot joint.

18. A device according to claim 13, wherein the device comprises an actuator, which is connected to the annular member for displacement of the annular member between a first and a second position, the positions corresponding to the first and second position of the hatch.

19. A device according to claim 1, wherein at least one of the hatches is provided with a stiffening structure in the circumferential direction of the device.

20. A gas turbine comprising the device according to claim 1.

21. An aircraft engine comprising the device according to claim 1.
